(19) United States
(12) Patent Application Publication
(10) Pub. No.: US 2020/0132908 A1
(43) Pub. Date: Apr. 30, 2020

(54) BACKLIGHT UNIT AND DISPLAY DEVICE INCLUDING THE SAME

(71) Applicant: Samsung Display Co., Ltd., Yongin-Si (KR)

(72) Inventors: Byung-seo YOON, Hwaseong-si (KR); Seong-yong HWANG, Hwaseong-si (KR); Jonghwan KIM, Busan (KR); Sung-kyu SHIM, Seoul (KR)

(21) Appl. No.: 16/524,670

(22) Filed: Jul. 29, 2019

(30) Foreign Application Priority Data
Oct. 24, 2018 (KR) 10-2018-0127503

(51) Int. Cl. F21V 8/00

(52) U.S. Cl. CPC G02B 6/0036; G02B 6/0068; G02B 6/005; G02B 6/0038

(57) ABSTRACT

A backlight unit includes a light guide plate, a low refractive layer disposed on the light guide plate, an optical conversion layer disposed on the low refractive layer, a light source adjacent to a side surface of the light guide plate, and a plurality of optical patterns disposed under the light guide plate, extending in a first direction intersecting the side surface, and disposed in a second direction intersecting the first direction. When viewed a plan view in the first direction, each of the optical patterns have a quadrilateral shape.

This application claims priority to Korean Patent Application No. 10-2018-0127503, filed on Oct. 24, 2018, and all the benefits accruing therefrom under 35 U.S.C. § 119, the content of which in its entirety is herein incorporated by reference.

### BACKGROUND

### 1. Field

The disclosure herein relates to a backlight unit and a display device including the backlight unit.

### 2. Description of the Related Art

Generally, a display device includes a display panel that displays an image using light, and a backlight unit that is disposed under the display panel and provides light to the display panel. The display panel includes a plurality of pixels for displaying an image. The pixels may display an image by adjusting the transmittance of the light provided from the backlight unit.

The backlight unit may be classified into an edge type backlight unit and a direct type backlight unit. The edge type backlight unit typically includes a light guide plate and a light source disposed adjacent one side of the light guide plate. One side of the light guide plate may be defined as a light-incident portion, and the light generated from the light source is provided to the light guide plate through the light-incident portion thereof.

### SUMMARY

In a display device using an edge-type backlight unit, the light density of the light-incident portion in the light guide plate is highest. Accordingly, the amount of light emitted upward through a predetermined portion of the light guide plate adjacent to the light-incident portion increases. Therefore, a light leakage phenomenon may occur where light is leaked at a predetermined portion of the light guide plate adjacent to the light-incident portion, resulting in a decrease in light efficiency.

The disclosure is to provide a backlight unit with reduced light leakage in a predetermined portion of a light guide plate adjacent to a light-incident portion and a display device including the backlight unit.

An embodiment of the invention provides a backlight unit including: a light guide plate; a low refractive layer disposed on the light guide plate; an optical conversion layer disposed on the low refractive layer; a light source adjacent to a side surface of the light guide plate; and a plurality of optical patterns disposed under the light guide plate, extending in a first direction intersecting the one side surface, and disposed in a second direction intersecting the first direction, where each of the optical patterns have a quadrilateral shape when viewed from a plan view in the first direction.

In an embodiment of the invention, a backlight unit includes: a light guide plate; a low refractive layer disposed on the light guide plate; an optical conversion layer disposed on the low refractive layer; a light source adjacent to a side surface of the light guide plate; a base layer disposed under the light guide plate; and a plurality of optical patterns protruding downward from the base layer, where the optical patterns extend in a first direction, which intersects the side surface, and are arranged in a second direction, which intersects the first direction, where each of the optical patterns have a quadrilateral shape when viewed from a plan view in the first direction.

In an embodiment of the invention, a display device includes: a display panel; a light guide plate disposed under the display panel; a low refractive layer disposed between the display panel and the light guide plate; an optical conversion layer disposed between the display panel and the low refractive layer; a light source adjacent to a side surface of the light guide plate; and a plurality of optical patterns disposed under the light guide plate, extending in a first direction intersecting the side surface, and arranged in a second direction intersecting the first direction, where each of the optical patterns have a quadrilateral shape when viewed from a plan view in the first direction.

### BRIEF DESCRIPTION OF THE FIGURES

These and/or other features of the invention will become apparent and more readily appreciated from the following description of the exemplary embodiments, taken in conjunction with the accompanying drawings, in which:

FIG. 1 is a perspective view of a display device according to an embodiment of the invention;

FIG. 2 is a view illustrating a configuration of a pixel shown in FIG. 1;

FIG. 3 is a cross-sectional view of the optical conversion layer shown in FIG. 1;

FIG. 4 is a plan view showing an optical layer disposed on a lower surface of the light guide plate shown in FIG. 1;

FIG. 5 is a cross-sectional view taken along line I-I′ of FIG. 4;

FIG. 6 is an enlarged view of a portion of the optical layer shown in FIG. 5;

FIG. 7 is a view for describing the function of the optical layer shown in FIG. 4;

FIGS. 8A, 8B, and 8C are views for describing a refraction of a first light in a comparative optical layer;

FIGS. 9A, 9B, 9C, and 9D are views for describing a refraction of a first light in an optical layer according to an embodiment of the invention;

FIG. 10 is a graph showing a luminance measured in a light guide plate where a comparative optical layer is disposed and a luminance measured in a light guide plate where an optical layer according to an embodiment of the invention is disposed; and

FIGS. 11 to 14 are views illustrating configurations of optical layers according to alternative embodiments of the invention.

### DETAILED DESCRIPTION

The invention now will be described more fully hereinafter with reference to the accompanying drawings, in which various embodiments are shown. The invention may, however, be embodied in many different forms, and should not be construed as limited to the embodiments set forth herein. Rather, these embodiments are provided so that this disclosure will be thorough and complete, and will fully convey the scopes of the invention to those skilled in the art. .

Like reference numerals refer to like elements throughout. Additionally, in the drawings, the thicknesses, proportions, and dimensions of components are exaggerated for effective description.

It will be understood that when an element such as a layer, region or substrate is referred to as being “on” another element, it can be directly on the other element or intervening elements may be present. In contrast, the term “directly” means that there are no intervening elements.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” “At least A and B” means “A and/or B.” “And/or” includes all of one or more combinations defined by related components.

It will be understood that the terms “first” and “second” are used herein to describe various components but these components should not be limited by these terms. The above terms are used only to distinguish one component from another. For example, a first component may be referred to as a second component and vice versa without departing from the scope of the invention. The singular expressions include plural expressions unless the context clearly dictates otherwise.

In addition, terms such as “below”, “the lower side”, “on”, and “the upper side” are used to describe a relationship of configurations shown in the drawing. The terms are described as a relative concept based on a direction shown in the drawing.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system).

Unless otherwise defined, all terms (including technical and scientific terms) used herein have the same meaning as terms commonly understood by those skilled in the art to which this invention belongs. Also, terms such as terms defined in commonly used dictionaries should be interpreted as having meaning consistent with meaning in the context of the related art, and unless the term is interpreted in an ideal or overly formal sense, they are explicitly defined here.

In various embodiments of the invention, the term “include,” “comprise,” “including,” or “comprising,” specifies a property, a region, a fixed number, a step, a process, an element and/or a component but does not exclude other properties, regions, fixed numbers, steps, processes, elements and/or components.

Hereinafter, embodiments of the invention are described in more detail with reference to the accompanying drawings.

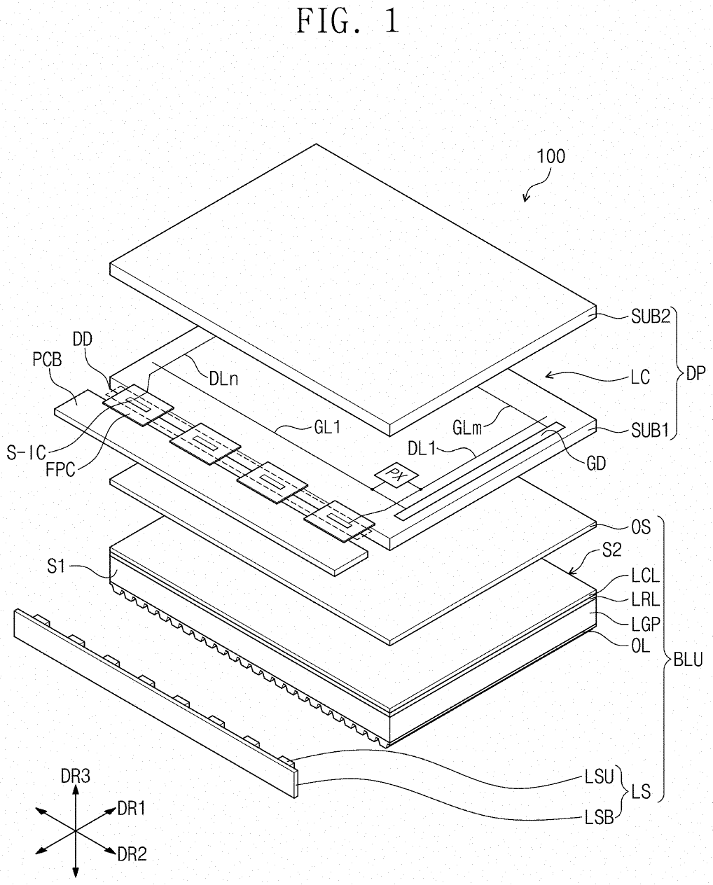

FIG. 1 is a perspective view of a display device according to an embodiment of the invention.

Referring to FIG. 1, an embodiment of a display device 100 according to the invention includes a display panel DP, a gate driving unit GD, a data driving unit DD, a printed circuit board PCB, and a backlight unit BLU. The display panel DP may have a rectangular shape having short sides in a first direction DR1 and long sides in a second direction DR2 that intersects the first direction DR1. However, the shape of the display panel DP may not be limited thereto.

The backlight unit BLU may generate the first light having a first color, convert the first light into the second light having a second color and provide the converted light to the display panel DP. The backlight unit BLU may be an edge type backlight unit. The display panel DP may display an image using the second light provided from the backlight unit BLU. The displayed image may be output to the user through the upper surface of the display panel DP. The first color may be a blue color, and the second color may be a white color.

The display panel DP includes a first substrate SUB1, a second substrate SUB2 facing the first substrate SUB1, and a liquid crystal layer LC disposed between the first substrate SUB1 and the second substrate SUB2. The first substrate SUB1 and the second substrate SUB2 may have a rectangular shape having short sides in the first direction DR1 and long sides in the second direction DR2.

FIG. 1 shows an embodiment where a liquid crystal display panel includes a liquid crystal layer LC as a display panel DP. However, the invention is not limited thereto, and various display panels for displaying images such as an electrophoretic display panel and an electrowetting display panel may be used as the display panel DP.

A plurality of pixels PX, a plurality of gate lines GL1 to GLm, and a plurality of data lines DL1 to DLn may be disposed on the first substrate SUB1. Here, m and n are natural numbers. For convenience of illustration and description, a single pixel PX is shown in FIG. 1, but a plurality of the pixels PX may be substantially disposed on the first substrate SUB1.

The gate lines GL1 to GLm and the data lines DL1 to DLn may be insulated from each other and intersect with each other. The gate lines GL1 to GLm may extend in the second direction DR2 and may be connected to a gate driving unit (e.g., a gate driver or a gate driving circuit) GD. The data lines DL1 to DLn may extend in the first direction DR1 and may be connected to a data driving unit (e.g., a data driver or a data driving circuit) DD. The pixels PX may be connected to the gate lines GL1 to GLm and the data lines DL1 to DLn.

The gate driving unit GD may be disposed on a predetermined portion of the first substrate SUB1 adjacent to one of the short sides of the first substrate SUB1. The gate driving unit GD may be formed at the same time as the transistors of the pixels PX and be mounted on the first substrate SUB1 in the form of an amorphous silicon thin film transistor (“TFT”) gate driver circuit (“ASG”) or an oxide silicon TFT gate driver (“OSG”).

However, the invention is not limited thereto, and the gate driving unit GD may be formed of a plurality of driving chips and may be mounted on the flexible printed circuit boards to be connected to the first substrate SUB1 by a tape carrier package (“TCP”) method. Alternatively, the driving chips of the gate driving unit GD may be mounted on the first substrate SUB1 by a chip-on-glass (“COG”) method.

The data driving unit DD may include a plurality of source driving chips S-IC mounted on flexible printed circuit boards FPC. An embodiment where four source drive chips S-IC and four flexible printed circuit boards FPC are provided is shown in FIG. 1, but the number of the source driving chips S-IC and the flexible printed circuit boards FPC is not limited thereto and may be variously modified depending on the size of the display panel DP.

One side of the flexible printed circuit boards FPC may be connected to one side of the first substrate SUB1. One side of the first substrate SUB1 may be defined by any one of long sides of the first substrate SUB1. The other sides of the flexible printed circuit boards FPC, which are opposite to the one sides of the flexible printed circuit boards FPC, may be connected to a printed circuit board PCB. The source driving chips S-IC may be connected to the first substrate SUB1 and the printed circuit board PCB through flexible printed circuit boards FPC.

A timing controller (not shown) may be disposed on a printed circuit board PCB. The timing controller may be mounted on a printed circuit board PCB in the form of an integrated circuit chip. The timing controller may be connected to the gate driving unit GD and the data driving unit DD through flexible printed circuit boards FPC. The timing controller may output a gate control signal, a data control signal, and image data.

The gate driving unit GD may receive a gate control signal from the timing controller and may generate a plurality of gate signals in response to the gate control signal. The gate driving unit GD may sequentially output the gate signals. The gate signals may be provided to the pixels PX through the gate lines GL1 to GLm.

The data driving unit DD may receive the image data and the data control signal from the timing controller. The data driving unit DD may generate and output analog data voltages corresponding to the image data in response to the data control signal. The data voltages may be provided to the pixels PX through the data lines DL1 to DLn.

The pixel PX may receive data voltages through the data lines DL1 to DLn in response to gate signals provided through the gate lines GL1 to GLm. As the pixel PX displays the grayscales corresponding to the data voltages, the display panel DP may display an image.

In an embodiment, the backlight unit BLU may include a light source LS, a light guide plate LGP, a low refractive layer LRL, an optical conversion layer LCL, an optical sheet OS, and an optical layer OL. The light guide plate LGP, the low refractive layer LRL, the optical conversion layer LCL, the optical sheet OS, and the optical layer OL may have a rectangular shape with short sides in the first direction DR1 and long sides in the second direction DR2. Hereinafter, the direction substantially perpendicular to the plane defined by the first and second directions DR1 and DR2 is defined by a third direction DR3.

The light source LS is disposed adjacent to one side surface S1 of opposing side surfaces Si and S2 of the light guide plate LGP facing each other in the first direction DR1 to face one side surface S1 of the light guide plate LGP. The opposing side surfaces S1 and S2 of the light guide plate LGP define the long sides of the light guide plate LGP and the one side surface S1 of the light guide plate LGP may be one of the long sides of the light guide plate LGP.

The light source LS may extend in the second direction DR2. The light source LS generates the first light, and the first light may be emitted to the one side surface S1 of the light guide plate LGP. The one side surface S1 of the light guide plate LGP may define a light-incident portion and the other side surface S2 of the light guide plate LGP, which is opposite to the one side surface S1 of the light guide plate LGP may define a light-focusing portion. Hereinafter, the light-incident portion will be referred to using the same symbol as the one side surface S1, and the light-focusing portion will also be referred to using the same symbol as the other side surface S2.

The light source LS may include a light source substrate LSB extending in a second direction DR2 and a plurality of light source units LSU disposed on the light source substrate LSB. The light source units LSU may be disposed at regular intervals in the second direction DR2. The light source units LSU may be disposed to face the one side surface Si of the light guide plate LGP. The light source LS generates the first light, and the first light may be provided on the one side surface Si of the light guide plate LGP.

The light guide plate LGP may include a transparent plastic or glass. The light guide plate LGP may be disposed under the display panel DP. The upper and lower surfaces of the light guide plate LGP may be on a plane defined by the first and second directions DR1 and DR2. Accordingly, the third direction DR3 may be a direction perpendicular to the upper surface and the lower surface of the light guide plate LGP. The light guide plate LGP may guide the first light provided from the light source units LSU to the upper direction where the display panel DP is disposed.

The low refractive layer LRL may be disposed between the display panel DP and the light guide plate LGP. An optical conversion layer LCL may be disposed between the display panel DP and the low refractive layer LRL. The low refractive layer LRL may be disposed on the light guide plate LGP to contact the upper surface of the light guide plate LGP. An optical conversion layer LCL may be disposed on the low refractive layer LRL to contact the upper surface of the low refractive layer LRL.

In an embodiment, the low refractive layer LRL may have a smaller refractive index than the light guide plate LGP. In such an embodiment, where the low refractive layer LRL has a smaller refractive index than the light guide plate LGP, some light traveling toward the upper surface of the light guide plate LGP may be totally reflected at the interface between the light guide plate LGP and the low refractive layer LRL. In such an embodiment, the first light may be provided to a low refractive layer LRL or may be totally reflected at an interface between the light guide plate LGP and the low refractive layer LRL, depending on the angle at which the first light is emitted. The totally-reflected light may travel toward the light-focusing portion S2 of the light guide plate LGP.

Light provided to the low refractive layer LRL may be provided to the optical conversion layer LCL. The optical conversion layer LCL may convert the first light into the second light and output the second light to the upper part. The second light may be diffused in the optical conversion layer LCL and be emitted to an upper part thereof.

The optical conversion layer LCL may include a plurality of quantum dots for converting a blue light into a white light. The optical conversion layer LCL may have a higher refractive index than the light guide plate LGP. The second light converted in the optical conversion layer LCL may be provided to the optical sheet OS.

In one embodiment, for example, the refractive index of the light guide plate LGP may be about 1.5, the refractive index of the low refractive layer LRL may be about 1.25, and the refractive index of the optical conversion layer LCL may be about 1.6.

The optical sheet OS may be disposed between the display panel DP and the optical conversion layer LCL. The optical sheet OS may include a diffusion sheet (not shown) and a prism sheet (not shown) disposed on the diffusion sheet.

The diffusion sheet may diffuse the second light provided from the optical conversion layer LCL. The prism sheet may condense the second light diffused in the diffusion sheet in the upper direction perpendicular to the plane. The second light passed through the prism sheet may progress in the upper direction toward the display panel DP with a uniform luminance distribution.

The optical layer OL may be disposed under the light guide plate LGP. The optical layer OL may have a same refractive index as the light guide plate LGP. The optical layer OL may guide the first light provided to a predetermined portion of the light guide plate LGP adjacent to the one side surface S1 toward the light-focusing portion S2. Such a configuration will be described later in greater detail.

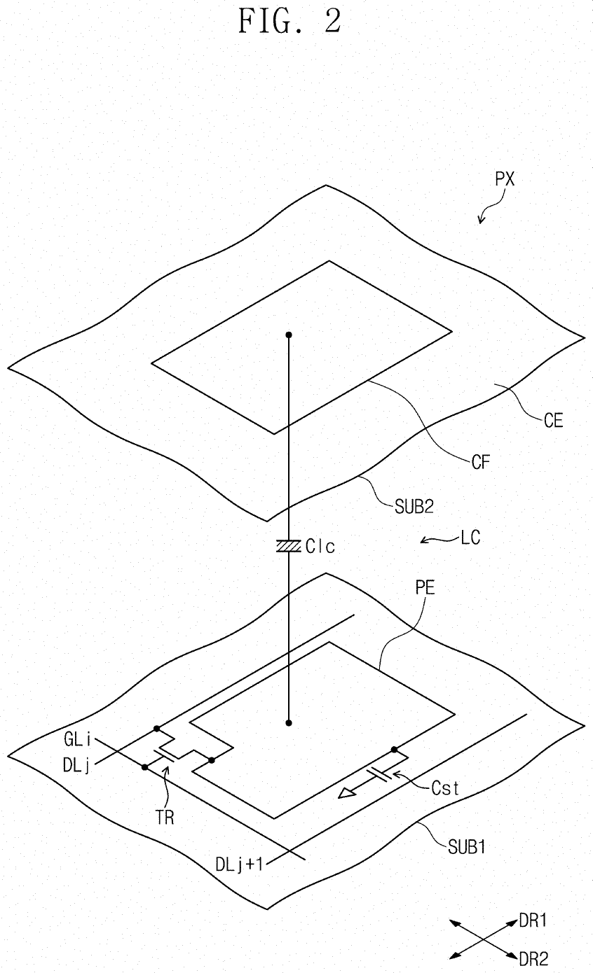

FIG. 2 is a view illustrating a configuration of a pixel shown in FIG. 1.

For convenience of illustration and description, a pixel PX connected to an i-th gate line GLi and a j-th data line DLj is shown in FIG. 2, and the configuration of the other pixels PX of the display panel DP will be the same as that of the pixel PX shown in FIG. 2.

Referring to FIG. 2, the pixel may include a transistor TR connected to the i-th gate line GLi and the j-th data line DLj, a liquid crystal capacitor Clc connected to the transistor TR, and a storage capacitor Cst connected in parallel to the liquid crystal capacitor Clc. Alternatively, the storage capacitor Cst may be omitted. Here, i and j are natural numbers.

The transistor TR may be disposed on the first substrate SUB1. The transistor TR may include a gate electrode (not shown) connected to the i-th gate line GLi, a source electrode (not shown) connected to the j-th data line DLj, and a drain electrode (not shown) connected to the liquid crystal capacitor Clc and the storage capacitor Cst.

The liquid crystal capacitor Clc may include a pixel electrode PE disposed on the first substrate SUB1, a common electrode CE disposed on the second substrate SUB2, and a liquid crystal layer LC disposed between the pixel electrode PE and the common electrode CE. The liquid crystal layer LC may serve as a dielectric. The pixel electrode PE may be connected to the drain electrode of the transistor TR.

In an embodiment, the pixel electrode PE may have a non-slit structure as shown in FIG. 2, but the invention is not limited thereto. Alternatively, the pixel PE may have a slit structure including a cross-shaped branch part and a plurality of branch parts extending radially from the cross-shaped branch part.

The common electrode CE may be disposed on an entire lower part of the second substrate SUB2. However, the invention is not limited thereto, and alternatively, the common electrode CE may be disposed on the first substrate SUB1. In such an embodiment, at least one of the pixel electrode PE and the common electrode CE may include a slit.

The storage capacitor Cst may include a pixel electrode PE, a storage electrode (not shown), which may be defined by a branched portion extending from a storage line (not shown), and an insulation layer disposed between the pixel electrode PE and the storage electrode. The storage line may be disposed on the first substrate SUB1 and may be disposed in a same layer as the gate lines GL1 to GLm. The storage electrode may partially overlap the pixel electrode PE.

The pixel PX may further include a color filter CF for representing one of red, green and blue colors. In an embodiment, as shown in FIG. 2, the color filter CF may be disposed on the second substrate SUB2. However, the invention is not limited thereto, and alternatively, the color filter CF may be disposed on the first substrate SUB1.

The transistor TR may be turned on in response to the gate signal provided through the i-th gate line GLi. The data voltage received via the j-th data line DLj may be provided to the pixel electrode PE of the liquid crystal capacitor Clc through the turned-on transistor TR. A common voltage may be applied to the common electrode CE.

An electric field may be generated between the pixel electrode PE and the common electrode CE due to the difference in the voltage levels of the data voltage and the common voltage. The liquid crystal molecules of the liquid crystal layer LC may be driven by an electric field generated between the pixel electrode PE and the common electrode CE. The light transmittance is adjusted by the liquid crystal molecules driven by the electric field, so that the image may be displayed.

A storage voltage having a constant voltage level may be applied to a storage line. However, the invention is not limited to this, and the storage line may receive the common voltage. The storage capacitor Cst may serve to compensate the charged amount of the liquid crystal capacitor Clc.

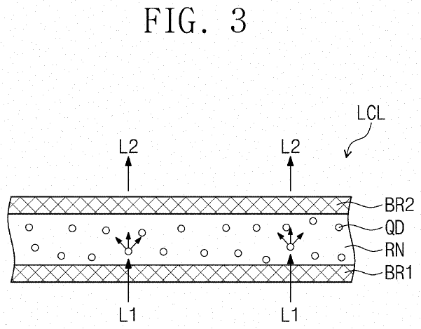

FIG. 3 is a cross-sectional view of the optical conversion layer shown in FIG. 1.

Referring to FIG. 3, in an embodiment, the optical conversion layer LCL includes a first barrier layer BR1, a second barrier layer BR2 disposed on the first barrier layer BR1, a resin RN disposed between the first barrier layer BR1 and the second barrier layer BR2, and a plurality of quantum dots QD accommodated or dispersed in the resin RN.

The first and second barrier layers BR1 and BR2 may include an inorganic material. The first and second barrier layers BR1 and BR2 and the resin RN may have a larger refractive index than the light guide plate LGP. The refractive index (e.g., about 1.6) of the optical conversion layer LCL mentioned above may be a refractive index of the resin RN, and the first and second barrier layers BR1 and BR2 may have a refractive index larger than that of the resin RN.

The optical conversion layer LCL may include quantum dots QD having different sizes from each other depending on the type of light source LS to generate a white light. In one embodiment, for example, when the light source LS generates a blue light L1, the optical conversion layer LCL may include quantum dots QD having a size that absorbs light in a blue wavelength band and emits light in a green wavelength band and quantum dots QD having a size that absorbs light of a blue wavelength band to emit light in a red wavelength band.

The quantum dots QD may absorb the blue light provided from the light source LS and convert the blue light into light in the green or red wavelength band. In such an embodiment, a part of the blue light may not be absorbed by the quantum dots QD. Accordingly, the light in the blue wavelength band, the light in green wavelength band and the light in red wavelength band may be mixed with each other in the optical conversion layer LCL to generate the second light L2, which is a white light. In such an embodiment, the quantum dots QD may diffuse the second light L2. The second light L2 diffused by the quantum dots QD may be provided to the optical sheet OS.

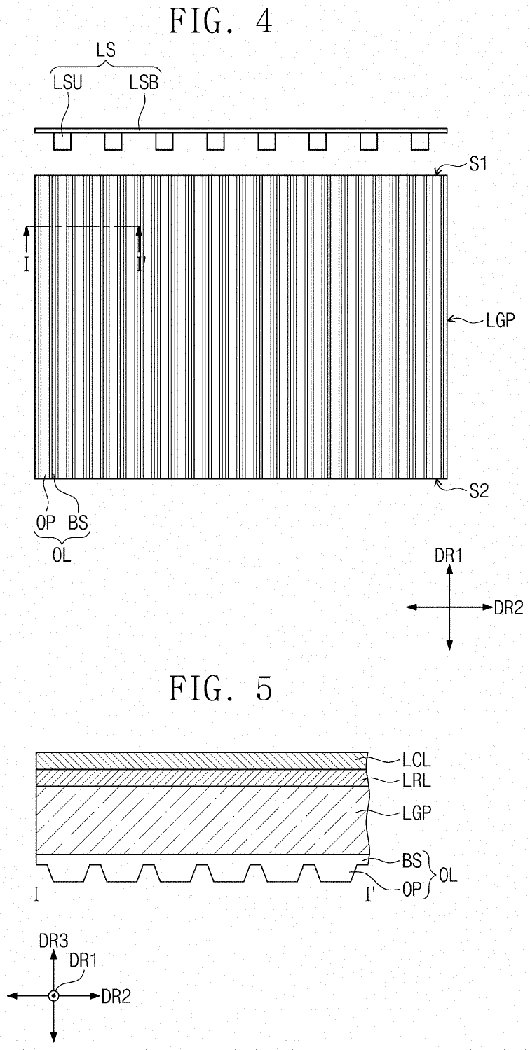

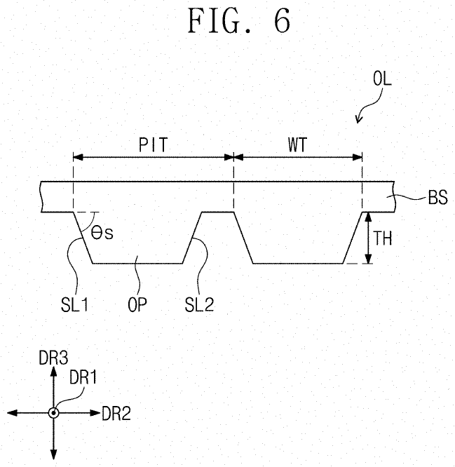

FIG. 4 is a plan view showing an optical layer disposed on a lower surface of the light guide plate shown in FIG. 1. FIG. 5 is a cross-sectional view taken along line I-I′ of FIG. 4.

Referring to FIGS. 4 and 5, the optical layer OL may be in a sheet form and attached to a lower surface of a light guide plate LGP. The optical layer OL may include a base layer BS and a plurality of optical patterns OP protruding from the base layer BS disposed under the light guide plate LGP. The base layer BS and the optical patterns OP may have a same refractive index as the light guide plate LGP.

The base layer BS may contact the lower surface of the light guide plate LGP. The optical patterns OP may protrude downward from the base layer BS. The base layer BS and the optical patterns OP may be integrally formed with each other as a single unitary and indivisible unit. In one embodiment, for example, a single sheet may be attached to the lower surface of the light guide plate LGP after forming predetermined patterns corresponding to the optical patterns OP on one side of the single sheet.

The optical patterns OP may extend in a direction intersecting the one side surface S1 of the light guide plate LGP. The direction intersecting the one side surface S1 may be the first direction DR1 and the first direction DR1 may be substantially perpendicular to the one side surface S1. The optical patterns OP may be spaced apart from each other in the second direction DR2.

When viewed from a plane view in the first direction DR1, each of the optical patterns OP may have a quadrilateral or quadrangle shape. In one embodiment, for example, when viewed from a plan view in the first direction DR1, the optical patterns OP may have an inverted trapezoidal shape. Thus, each of the optical patterns OP may include upper and lower sides parallel to each other and opposing oblique sides defined by inclined surfaces. The width of each of the optical patterns OP with respect to the second direction DR2 may become smaller toward the lower part.

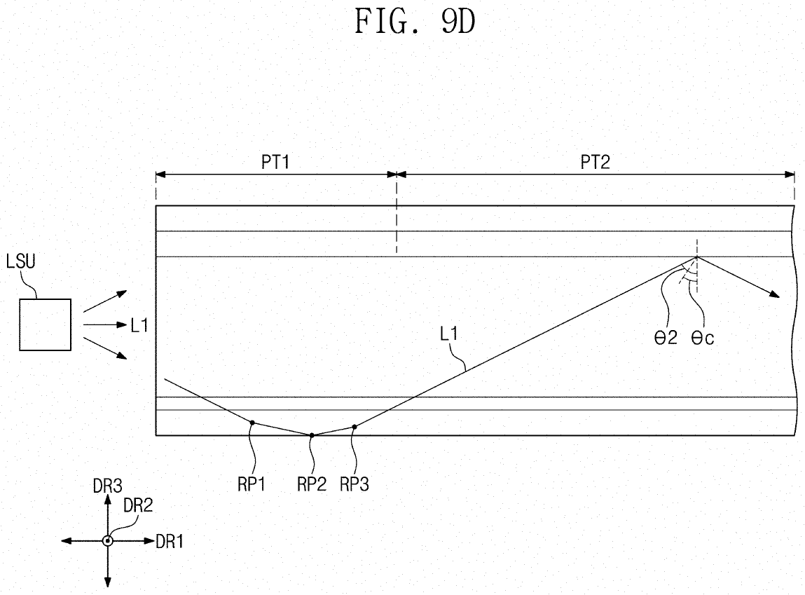

However, the invention is not limited thereto. In such an embodiment, each of the optical patterns OP has a quadrilateral shape, and the quadrilateral shape of the optical patterns OP may be variously modified. Various quadrilateral shapes of the optical patterns OP will be described later in greater detail with reference to FIGS. 11 to 14.

The number of the optical patterns OP may be greater than the number of the light source units LSU. A predetermined number of optical patterns OP may be disposed under the light guide plate LGP in correspondence to one light source unit LSU. In FIGS. 4 and 5, one embodiment where eight light source units LSU and 24 optical patterns OP are provided is shown, but the number of the light source units LSU and the number of the optical patterns OP are not limited thereto.

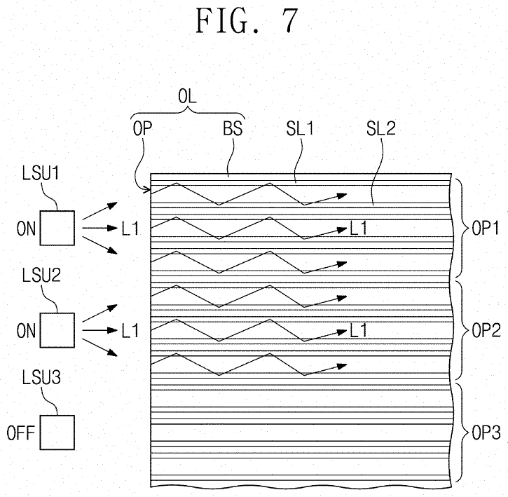

FIG. 6 is an enlarged view of a portion of the optical layer shown in FIG. 5.

For convenience of illustration and description, a portion of the optical layer OL where two optical patterns OP are disposed is enlarged and shown in FIG. 6.

Referring to FIG. 6, in an embodiment, opposing side surfaces SL1 and SL2 of each of the optical patterns OP defined by opposing oblique sides of inversed trapezoids may be symmetrical to each other. In one embodiment, for example, the first side surface SL1 of the opposing side surfaces SL1 and SL2 may be an inclined surface forming a predetermined inclination angle θs with the second direction DR2. The second side surface SL2, which is opposite to the first side surface SL1, may be an inclined surface symmetrical to the first side surface SL1. The inclination angle θs may be less than about 90 degrees. In an embodiment, the inclination angle θs may be greater than or equal to about 60 degrees or and less than about 90 degrees.

The width WT of each of the optical patterns OP may be defined by a distance between the upper ends of the first and second side surfaces SL1 and SL2 in the second direction DR2. The thickness TH of each of the optical patterns OP may be defined by a distance between the upper surface and the lower surface of each of the optical patterns OP in the third direction DR3.

In an embodiment, as shown in FIG. 6, the width WT of each of the optical patterns OP may be larger than the thickness TH of each of the optical patterns OP. However, the invention is not limited thereto, and alternatively, the width WT of each of the optical patterns OP may be smaller than the thickness TH of each of the optical patterns OP. In one embodiment, for example, the width WT of each of the optical patterns OP may be in a range of about 10 micrometers (pm) to about 300 μm. The thickness TH of each of the optical patterns OP may be in a range of about 3 μm to about 50 μm.

In an embodiment, the pitch PIT of the optical patterns OP, which his defined by the distance from the upper end of the first side surface SL1 of the h-th optical pattern OP to the upper end of the first side surface SL1 of the (h+1)-th optical pattern OP in the second direction DR2, may be in a range of about 20 μm to about 500 μm. In FIG. 6, the h-th optical pattern OP may be an optical pattern OP disposed on the left side, and the (h+1)-th optical pattern OP may be an optical pattern OP disposed on the right side.

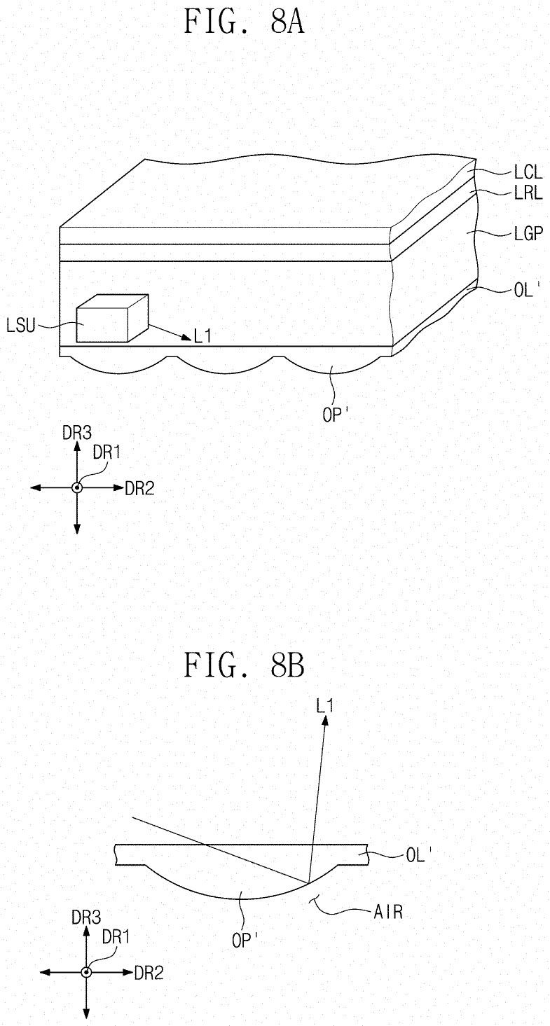

FIG. 7 is a view for describing the function of the optical layer shown in FIG. 4.

Hereinafter, the traveling direction of the first light L1 will be described with reference to a two-dimensional plane defined by the first and second directions DR1 and DR2.

Referring to FIG. 7, the first and second light source units LSU1 and LSU2 of the light source units LSU1, LSU2, and LSU3 are turned on and the first light L1 generated in the first and second light source units LSU1 and LSU2 may be provided or emitted to the light guide plate LGP. The first light L1 provided in the light guide plate LGP may be provided in or guided by the optical patterns OP.

The first light L1 generated in the first light source unit LSU1 may be provided in the three optical patterns OP1 adjacent to the first light source unit LSU1 (hereinafter, will also be referred to as first optical patterns OP1). The first light L1 provided in the first optical patterns OP1 may be reflected by the first and second side surfaces SL1 and SL2 of each of the first optical patterns OP1 and may travel in the first direction DR1 in each of the first optical patterns OP1. Therefore, the first light L1 generated in the first light source unit LSU1 may be guided to specific areas defined by the first optical patterns OP1.

The first light L1 generated in the second light source unit LSU2 may be provided in the three optical patterns OP2 adjacent to the second light source unit LSU2 (hereinafter, will also be referred to as second optical patterns OP2). The first light L1 provided in the second optical patterns OP2 may be reflected by the first and second side surfaces SL1 and SL2 of each of the second optical patterns OP2 and may travel in the first direction DR1 in each of the second optical patterns OP2. Therefore, the first light L1 generated in the second light source unit LSU2 may be guided to specific areas defined by the second optical patterns OP2.

In such an embodiment, since the third light source unit LSU3 is in the off state, the first light L1 may not be provided from the third light source unit LSU3 to the three optical patterns OP3 adjacent to the third light source unit LSU3 (hereinafter, will also be referred to as third optical patterns OP3). However, a part of the first light L1 generated in the second light source unit LSU2 may be provided to the third optical patterns OP3. But, since the third light source unit LSU3 is turned off, the luminance of the region where the third optical patterns OP3 are disposed may be relatively lower than the luminance of the region where the first and second optical patterns OP1 and OP2 are disposed.

The local dimming is defined by an operation of dividing the display panel DP into predetermined blocks and selectively controlling the light source units LSU corresponding to the blocks according to the luminance of the image to be displayed in each of the blocks. In one embodiment, for example, the display panel DP may include a first block overlapping the first optical patterns OP1, a second block overlapping the second optical patterns OP2, and a third block overlapping the third optical patterns OP3.

In an embodiment, the luminance of the image to be displayed on the first and second blocks of the display panel DP may be high and the luminance of the image to be displayed on the third block of the display panel DP may be low based on a result of analyzing the image to be displayed. In such an embodiment, by turning on the first and second light source units LSU1 and LSU2 and turning off the third light source unit LSU3, the first light L1 may be guided along the first and second optical patterns OP1 and OP2. Therefore, the luminance of the first and second blocks may be high, and the luminance of the third block may be low.

If the optical patterns OP were not provided, the first light L1 may not be guided in units of specific areas but may be diffused to all areas of the light guide plate LGP. Therefore, local dimming may not be effectively performed. In an embodiment, by arranging the optical patterns OP as described herein, the first light L1 may be guided by a specific area unit (for example, a block unit of the display panel DP) corresponding to the optical patterns OP, such that the luminance may be controlled based on a specific area unit.

For convenience of illustration and description, although the first, second, and third light source units LSU1, LSU2, LSU3 are shown in FIG. 7, other light source units LSUs may also selectively operate to perform local dimming according to the luminance of the corresponding blocks.

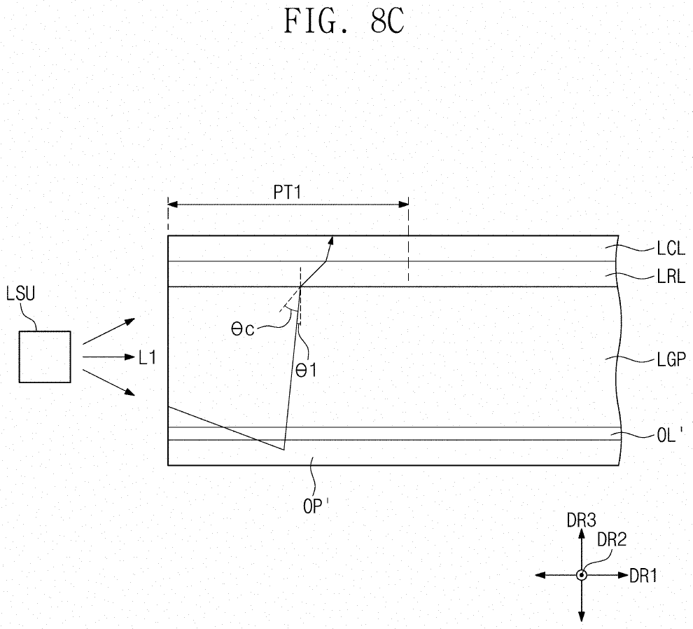

FIGS. 8A, 8B, and 8C are views for describing a refraction of a first light in a comparative optical layer.

In FIG. 8A, predetermined portions of a light guide plate LGP and a comparative or conventional optical layer OL′ viewed in a first direction DR1 are shown. In FIG. 8B, a cross-sectional view of one comparative optical pattern OP′ of the comparative optical layer OL′ viewed in the first direction DR1 is shown. In FIG. 8C, predetermined portions of a light guide plate LGP and a comparative optical layer OL′ viewed in a second direction DR2 are shown.

Except for the comparative optical pattern OP′ in FIGS. 8A and 8C, the light source unit LSU, the light guide plate LGP, the low refractive layer LRL, and the optical conversion layer LCL may be identical to the light source unit LSU, the light guide plate LGP, the low refractive layer LRL, and the optical conversion layer LCL of an embodiment of the invention shown in FIG. 1. Therefore, description of other configurations except for the comparative optical pattern OP′ in FIGS. 8A and 8C will be omitted.

Referring to FIG. 8A, a comparative optical layer OL′ disposed under a light guide plate LGP may include a plurality of comparative optical patterns OP′. The comparative optical patterns OP′ may have a convex shape protruding downward. Thus, the lower surface of each of the comparative optical patterns OP′ may have a curved surface. The first light L1 generated in the light source unit LSU may be provided to the comparative optical patterns OP′ through the one side surface S1.

Referring to FIG. 8B, the refractive index of the comparative optical pattern OP′ is larger than the refractive index of the air layer AIR, and the first light L1 may be reflected at the interface between the comparative optical pattern OP′ and the air layer AIR. Since the lower surface of the comparative optical pattern OP′ has a curved surface, the first light L1 toward the comparative optical pattern OP′ is reflected at the interface between the comparative optical pattern OP′ and the air layer AIR and may travel in the upper direction.

Referring to FIG. 8C, a predetermined portion of the light guide plate LGP adjacent to one side surface S1 may be defined by a first portion PT1. The first light L1 provided in the first portion PT1 may be reflected at the interface between the comparative optical pattern OP′ and the air layer AIR and travel in the upper direction. The first light L1 traveling in the upper direction may travel toward the interface between the first portion PT1 and the low refractive layer LRL.

The incident angle θ1 of the first light L1 may be smaller than the total reflection critical angle Oc depending on the refractive index of the low refractive layer LRL and the refractive index of the light guide plate LGP. Therefore, after transmitting the interface between the first portion PT1 and the low refractive layer LRL, the first light L1 may be provided to the optical conversion layer LCL through the low refractive layer LRL. The first light L1 may be converted to the second light L2 in the optical conversion layer LCL and may be emitted upward.

When the first light L1 generated in the light source unit LSU is provided to the light guide plate LGP, the light density at the light-incident portion S1 may be the highest. The first light L1 passing through the one side surface S1 is not guided toward the light-focusing portion S2 but is reflected by the comparative optical pattern OP′ to be emitted at the first portion PT1. Since the light density of the light-incident portion S1 is the highest, the amount of light outputted through the first portion PT1 may also be substantially great.

As the amount of light outputted through the first portion PT1 becomes greater, the luminance of the first portion PT1 may become higher than other portions of the light guide plate LGP. Therefore, the uniformity of the light emitted from the light guide plate LGP may be reduced. Such a phenomenon may be defined as a light leakage phenomenon where the first light L1 is leaked in the first portion PT1.

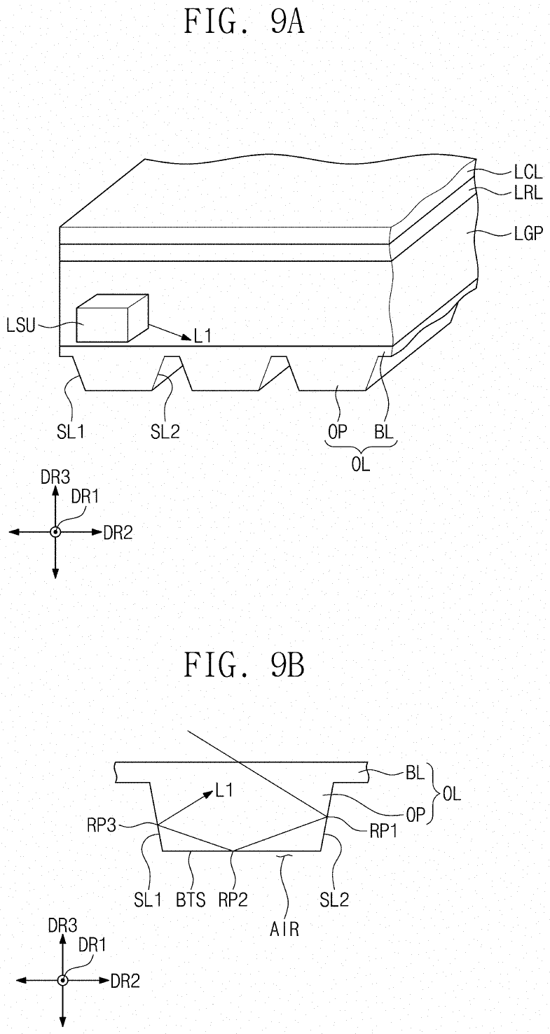

FIGS. 9A, 9B, 9C, and 9D are views for describing a refraction of a first light in an optical layer according to an embodiment of the invention.

In FIG. 9A, predetermined portions of a light guide plate LGP and an optical layer OL viewed in a first direction DR1 are shown. In FIG. 9B, a cross-sectional view of one optical pattern OP viewed in the first direction DR1 is shown.

In FIG. 9C, a predetermined portion of one optical pattern OP viewed in the third direction DR3 is shown. A predetermined portion of the optical pattern OP shown in FIG. 9C may be a predetermined portion of the optical pattern OP adjacent to one side surface Si. In FIG. 9D, predetermined portions of a light guide plate LGP and an optical layer OL viewed in a second direction DR2 are shown.

Referring to FIG. 9A, a first light L1 generated in a light source unit LSU may be provided to a light guide plate LGP. Since the optical layer OL has the same refractive index as the light guide plate LGP, the first light L1 provided in the light guide plate LGP may be provided to the optical layer OL through the light guide plate LGP.

Referring to FIGS. 9B and 9C, the first light L1 is provided to the optical pattern OP and is reflected at the first reflection point RP1 of the interface between the second side surface SL2 and the air layer AIR. The first light L1 reflected at the first reflection point RP1 may travel toward the bottom surface BTS of the optical pattern OP and may be reflected at the second reflection point RP2 of the interface between the bottom surface BTS and the air layer AIR.

The first light L1 reflected at the second reflection point RP2 may travel toward the first side surface SL1 and may be reflected at the third reflection point RP3 of the interface between the first side surface SL1 and the air layer AIR. As shown in FIG. 9C, when viewed in the third direction DR3, the first light L1 may be reflected at each of the first, second and third reflection points RP1, RP2, and RP3, and may travel along the first direction DR1.

Referring to FIG. 9D, the first light L1 provided to the first portion PT1 may be reflected at each of the first second, and third reflection points RP1, RP2 and RP3, and may travel in the upper direction. The first light L1 traveling in the upper direction may not be provided to the first portion PT1 of the light guide plate LGP and may be provided to the second portion PT2 of the light guide plate LGP farther from the one side surface S1 than the first portion PT1.

Since the comparative optical pattern OP′ has a curved surface, the first light L1 may be reflected and provided toward the upper surface of the first portion PT1. But, since the optical pattern OP has a quadrilateral or trapezoidal shape, the first light L1 may be reflected by the first and second side surfaces SL1 and SL2 forming a predetermined angle θs with a second direction DR2 and having a flat inclined surface and may be provided to the second portion PT2.

The incident angle θ2 of the first light L1 shown in FIG. 9D may be larger than the incident angle θ1 of the first light L1 shown in FIG. 8C. In such an embodiment, the incident angle θ2 of the first light L1 may be greater than the total reflection critical angle θc. Thus, the first light L1 may be totally reflected at the interface between the second portion PT2 of the light guide plate LGP and the low refractive layer LRL and then, may travel toward the light-focusing portion S2. In such an embodiment, the first light L1 is reflected at the second portion PT2 and guided toward the light-focusing portion S2 without being emitted through the first portion PT1, such that the light leakage phenomenon of the first portion PT1 may be reduced.

In an embodiment, as described above, the display device 100 guides the first light L1 provided in the first portion PT1 toward the light-focusing portion S2 without emitting the light in the first portion PT1, such that the light leakage phenomenon may be reduced and the light uniformity may be improved.

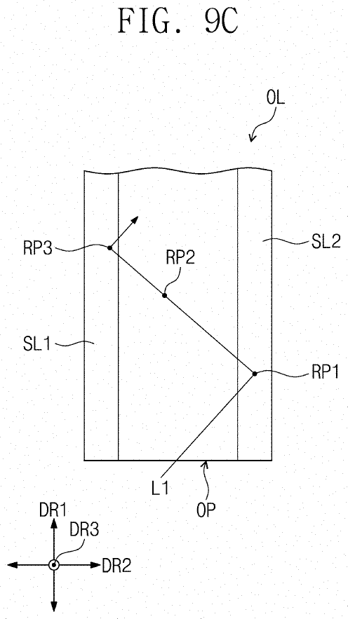

FIG. 10 is a graph showing a luminance measured in a light guide plate where a comparative optical layer is disposed and a luminance measured in a light guide plate where an optical layer according to an embodiment of the invention is disposed.

The first graph G1 shows the luminance measured at the light guide plate LGP where the comparative optical layer OL′ is disposed. The second graph G2 shows the luminance measured at the light guide plate LGP where the optical layer OL is disposed according to the embodiment of the invention.

In FIG. 10, the horizontal axis represents the distance (unit: mm) and the vertical axis represents the luminance (unit: nit). In FIG. 10, one side surface Si of the light guide plate LGP is set to be 0, the distance on the horizontal axis represents the distance from the one side surface S1 of the light guide plate LGP. Here, the length of the light guide plate LGP may be about 1400 mm, but the luminance of the light guide plate LGP up to about 400 mm is shown in FIG. 10 for convenience of illustration and description.

Referring to FIG. 10, in the first graph G1, the luminance may be increased as it becomes adjacent to one side surface S1 of the light guide plate LGP. Illustratively, the first portion PT1 may be defined by a portion of the light guide plate LGP from one side surface S1 of the light guide plate LGP to 100 mm. Therefore, as described above, the amount of light leaked in the first portion PT1 increases so that the light leakage may be increased.

However, referring to the second graph G2, it may be shown that the light amount of the first portion PT1 is smaller than that of the first graph G1. That is, when the optical layer OL is disposed under the light guide plate LGP, the amount of light leaked from the first portion PT1 decreases, so that the light leakage may be reduced. As a result, the light uniformity may be improved in the second graph G2 when compared with the first graph G1.

FIGS. 11 to 14 are views illustrating configurations of optical layers according to alternative embodiments of the invention.

For convenience of illustration and description, a cross-section of each of alternative embodiments of the optical layer OL1 to OL4 are shown in FIGS. 11 to 14. Hereinafter, the configuration of embodiments of the optical layer OL1 to OL4 shown in FIGS. 11 to 14 will be described focusing on a different configuration from the optical layer OL shown in FIGS. 5 and 6, and the same components are denoted by the same reference numerals.

Referring to FIG. 11, in an alternative embodiment, the optical layer OL1 may include a base layer BL and a plurality of optical patterns OP1_1 protruding from the base layer BL. The optical patterns OP1_1 may have an inverted trapezoidal shape.

In such an embodiment, the optical patterns OP1_1 may contact each other without being separated from each other in the second direction DR2. In one embodiment, for example, the upper ends of opposing side surfaces SL1 and SL2 of the optical patterns OP1_1 adjacent to each other among the optical patterns OP1_1 may contact each other. In such an embodiment, the upper end of the second side surface SL2 of the h-th optical pattern OP1_1 may contact the upper end of the first side surface SL1 of the (h+1)-th optical pattern OP1_1.

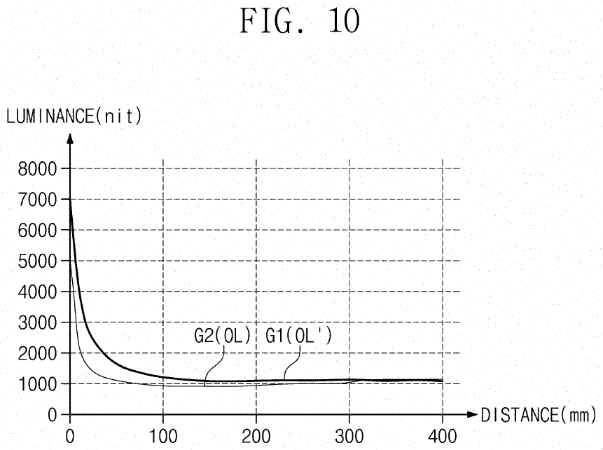

Referring to FIG. 12, in another alternative embodiment, the optical layer OL2 may include a base layer BL and a plurality of optical patterns OP2_1 protruding from the base layer BL. The optical patterns OP2_1 may have a rectangular shape. In one embodiment, for example, the optical patterns OP2_1 have an inverted trapezoidal shape, and opposing side surfaces SL1_1 and SL2_1 of each of the optical patterns OP2_1 may be asymmetric to each other.

In such an embodiment, the width of each of the optical patterns OP_1 with respect to the second direction DR2 may become smaller toward the lower part. The first side surface SL1_1 of each of the optical patterns OP2_1 may extend perpendicularly to the second direction DR2. The second side surface SL2_1 of each of the optical patterns OP2_1 may be an inclined surface forming the inclination angle θs with the second direction DR2.

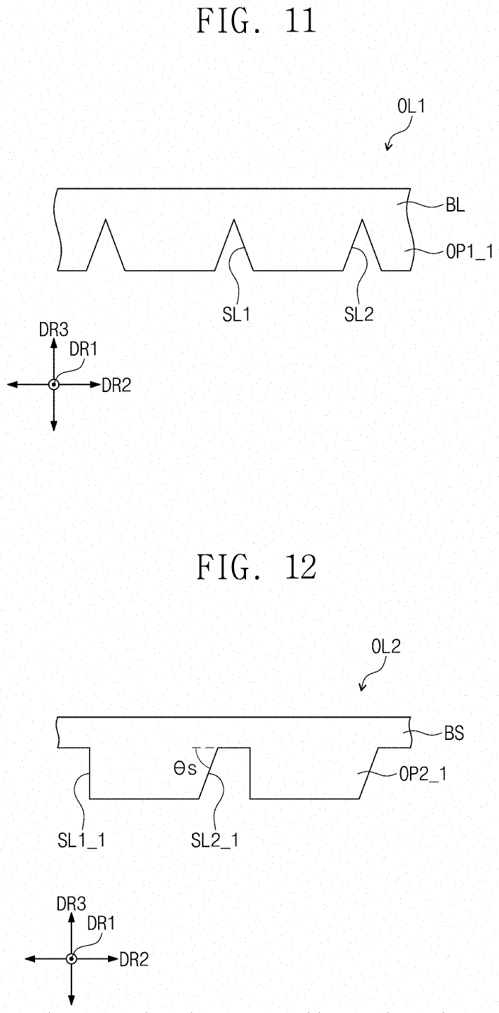

Referring to FIG. 13, in another alternative embodiment, the optical layer OL3 may include a base layer BL and a plurality of optical patterns OP3_1 protruding from the base layer BL. In one embodiment, for example, the optical patterns OP3_1 have an inverted trapezoidal shape, and opposing side surfaces SL1_2 and SL2_2 of each of the optical patterns OP3_1 may be asymmetric to each other.

The optical patterns OP3_1 may have an opposite shape to the optical patterns OP2_1 shown in FIG. 12. In one embodiment, for example, the first side surface SL1_2 of each of the optical patterns OP3_1 may be an inclined surface forming the inclination angle θs with the second direction DR2. The second side surface SL2_2 of each of the optical patterns OP3_1 may extend perpendicularly to the second direction DR2.

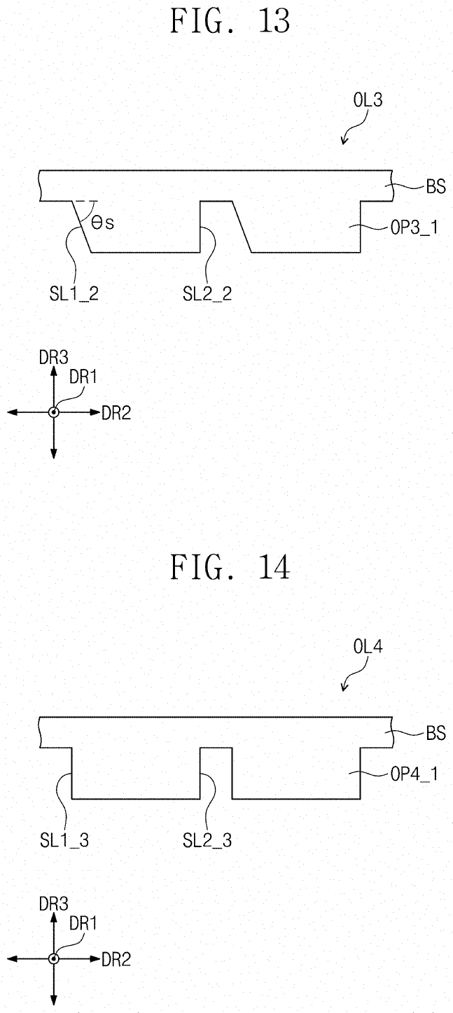

Referring to FIG. 14, in another alternative embodiment, the optical layer OL4 may include a base layer BL and a plurality of optical patterns OP4 1 protruding from the base layer BL. The optical patterns OP4_1 have a tetragonal shape, and may have a rectangular cross-sectional shape. Therefore, the first side surface SL1_3 and the second side surface SL2_3 of each of the optical patterns OP3_1 may extend perpendicular to the second direction DR2.

In such an embodiment, opposing side surfaces SL1 to SL1_3 and SL2 to SL2_3 of the optical patterns OP1_1 to OP4_1 shown in FIGS. 11 to 14 have no curved surface and have a flat surface, the first light L1 is reflected and proceeded to the second portion PT2 as in the optical patterns OP shown in FIGS. 5 and 6.

According to embodiments of the invention, optical patterns having a quadrilateral or quadrangle shape are disposed or defined under the light guide plate, and light provided in the first portion of the light guide plate adjacent to the light-incident portion may be guided toward the light-focusing portion without being emitted in the first portion by the optical patterns. Therefore, the light leakage at the first portion may be reduced, and the light uniformity may be improved.

Although some exemplary embodiments of the invention have been described, it is understood that the invention should not be limited to these exemplary embodiments but various changes and modifications may be made by one ordinary skilled in the art within the spirit and scope of the invention as hereinafter claimed.

What is claimed is:

1. A backlight unit comprising:
a light guide plate;
a low refractive layer disposed on the light guide plate;
an optical conversion layer disposed on the low refractive layer;
a light source adjacent to a side surface of the light guide plate; and
a plurality of optical patterns disposed under the light guide plate, extending in a first direction intersecting the side surface, and disposed in a second direction intersecting the first direction,
wherein each of the optical patterns has a quadrilateral shape when viewed from a plan view in the first direction.

2. The backlight unit of claim 1, further comprising:
a base layer disposed under the light guide plate,
wherein the optical patterns protrude downwardly from the base layer.

3. The backlight unit of claim 2, wherein
the base layer contacts a lower surface of the light guide plate, and
the base layer and the optical patterns are integrally formed with each other as a single unitary and indivisible unit.

4. The backlight unit of claim 2, wherein each of the base layer and the optical patterns has a refractive index equal to a refractive index of the light guide plate.

5. The backlight unit of claim 1, wherein each of the optical patterns has an inverted trapezoidal shape when viewed from the plan view in the first direction.

6. The backlight unit of claim 5, wherein opposing side surfaces of each of the optical patterns defined by oblique sides of the inverse trapezoidal shape are symmetrical to each other.

7. The backlight unit of claim 6, wherein a first side surface of the opposing side surfaces is inclined and forms an angle greater than or equal to about 60 degrees and less than about 90 degrees with the second direction.

8. The backlight unit of claim 6, wherein a width of each of the optical patterns defined by a distance between upper ends of the opposing side surfaces in the second direction is greater than a thickness of each of the optical patterns in a third direction perpendicular to a lower surface of the light guide plate.

9. The backlight unit of claim 6, wherein a width of each of the optical patterns defined by a distance between upper ends of the opposing side surfaces in the second direction is less than a thickness of each of the optical patterns in a third direction perpendicular to a lower surface of the light guide plate.

10. The backlight unit of claim 6, wherein
a width of each of the optical patterns defined by a distance between upper ends of the opposing side surfaces in the second direction is in a range of about 10 micrometers to about 300 micrometers, and
a thickness of each of the optical patterns in a third direction perpendicular to a lower surface of the light guide plate is in a range of about 3 micrometers to about 50 micrometers.

11. The backlight unit of claim 6, wherein a pitch of the optical patterns defined by a distance from an upper end of a first side surface of an h-th optical pattern to an upper end of a first side surface of an (h+1)-th optical pattern among the optical patterns in the second direction is in a range of about 20 micrometers to about 500 micrometers, wherein h is a natural number.

12. The backlight unit of claim 1, wherein
the light source comprises a plurality of light source units arranged in the second direction, and
the number of the optical patterns is greater than the number of the light source units.

13. The backlight unit of claim 1, wherein
the low refractive layer contacts an upper surface of the light guide plate, and
the optical conversion layer contacts an upper surface of the low refractive layer.

14. The backlight unit of claim 13, wherein
the low refractive layer has a refractive index less than a refractive index of the light guide plate, and
the optical conversion layer has a refractive index greater than the refractive index of the light guide plate.

15. The backlight unit of claim 1, wherein
the light source generates a first light having a first color, and
the optical conversion layer converts the first light into a second light having a second color.

16. The backlight unit of claim 1, wherein the optical patterns are spaced apart from each other in the second direction.

17. The backlight unit of claim 1, wherein upper ends of opposing side surfaces of optical patterns adjacent to each other among the optical patterns contact each other when viewed from the plan view in the first direction.

18. The backlight unit of claim 1, wherein
each of the optical patterns has an inverted trapezoidal shape when viewed from the plan view in the first direction, and
opposing side surfaces of each of the optical patterns defined by both oblique sides of the inverted trapezoid are asymmetric to each other when viewed from the plan view in the first direction.

19. The backlight unit of claim 1, wherein each of the optical patterns has a rectangular shape when viewed from the plan view in the first direction.

20. A backlight unit comprising:
a light guide plate;
a low refractive layer disposed on the light guide plate;
an optical conversion layer disposed on the low refractive layer;
a light source adjacent to a side surface of the light guide plate;
a base layer disposed under the light guide plate; and
a plurality of optical patterns protruding downward from the base layer,
wherein the optical patterns extend in a first direction, which intersects the side surface, and are arranged in a second direction, which intersects the first direction,
wherein each of the optical patterns has a quadrilateral shape when viewed from a plan view in the first direction.
